(19) United States
(12) Patent Application Publication
(10) Pub. No.: US 2023/0137709 A1
(43) Pub. Date: May 4, 2023

(54) SHIELDED cPVC PIPE AND BANDAGE

(71) Applicant: Hilti Aktiengesellschaft, Schaan (LI)

(72) Inventor: Christian Förg, Buchloe (DE)

(73) Assignee: Hilti Aktiengesellschaft, Schaan (LI)

(21) Appl. No.: 18/046,582

(22) Filed: Oct. 14, 2022

Related U.S. Application Data
(60) Provisional application No. 63/272,809, filed on Oct. 28, 2021.

(51) Int. Cl. F16L 59/02; F16L 9/127

(52) U.S. Cl. CPC F16L 59/029; F16L 9/127; F16L 59/028

(57) ABSTRACT

A shielded pipe contains a pipe from chlorinated polyvinyl chloride (cPVC) and a collar which shields the pipe from the environment. The collar contains a bandage which is wrapped around the cPVC pipe, where the bandage contains a carrier layer and a functional layer. The shielded pipe can be used in a corresponding a wall duct. The bandage is useful for shielding a pipe.

### CROSS-REFERENCE TO RELATED APPLICATIONS

This application claims priority to U.S. Provisional Application No. 63/272,809, filed on Oct. 28, 2021, the content of which is hereby incorporated by reference in its entirety.

### BACKGROUND OF THE INVENTION

### Field of the Invention

The invention relates to a shielded pipe, comprising a pipe from chlorinated polyvinyl chloride and a collar which shields the pipe from the environment. The invention also relates to a wall duct, a bandage and uses thereof.

### Description of Related Art

Pipes from chlorinated polyvinyl chloride (cPVC) are used in building applications for conducting fluids, especially water, for example in sprinkler systems or cold or hot water pipes. cPVC pipes have various advantages over metal pipes, such as low weight, low thermal extension, easy installation, low corrosion, low thermal conductance and high life span. However, it is a problem that cPVC pipes are not compatible with various chemicals, which are also used in respective building applications. For example, the pipes can be damaged by oils, softeners from plastics, components from sealants, anti-freeze or fire-resistant materials. Such chemicals can render the pipes brittle, which can lead to cracks or other damages under tension. This is especially a problem in wall ducts or similar systems, where the annular gap around the pipe is closed with for example mastics, sealants, materials based on acrylics, latex, silicon, at the contact site.

In the art, the problem is generally addressed by determining in advance, if a specific cPVC pipe is compatible with the specific materials and chemicals of a desired system. For example, the FBC™ System Compatible Program (company Lubrizol, US) shall allow a reliable selection and screening of chemicals, based on a physical testing approach. However, performing such advance testing on a routine basis in budding applications can be burdensome, time-consuming and costly. Besides, even stringent testing procedures are not always reliable, because plastic materials can undergo changes and some chemicals are known to creep into and through plastic materials during prolonged use. Thus, even systems which may seem secure in an advanced compatibility tests may incur problems in practical applications, especially after prolonged time periods. Besides, cPVC pipes are generally not highly stable against fire, heat or smoke.

### SUMMARY OF THE INVENTION

It is a problem underlying the invention to provide products, uses or methods which overcome the disadvantages described above, Specifically, it is a problem underlying the invention to provide cPVC pipes or systems, which are highly stable in standard building applications; and specifically when contacting a wider range of chemicals, plastic materials or sealings. It is a further problem to provide respective products which are stable in the presence of fire, heat or smoke.

The problem is solved by a shielded pipe, a wall duct, a bandage and use of a bandage as described below. Further embodiments are outlined in the description.

Subject of the invention is a shielded pipe, comprising
a pipe from chlorinated polyvinyl chloride (cPVC) and
a collar which shields the cPVC pipe from the environment,
wherein the collar comprises a bandage which is wrapped around the cPVC pipe, wherein the bandage comprises a carrier layer and a functional layer.

The invention also includes the following embodiments;

1. A shielded pipe (1), comprising
a pipe (2) from chlorinated polyvinyl chloride (cPVC) and
a collar (3) which shields the cPVC pipe (2) from the environment,
wherein the collar (3) comprises a bandage (4) which is wrapped around the cPVC pipe (2), wherein the bandage (4) comprises a carrier layer (6) and a functional layer (7).

2. The shielded pipe (1) according to embodiment 1, wherein the carrier layer (6) is a metal foil.

3. The shielded pipe (1) according to embodiment 1 and/or 2, wherein the functional layer (7) has the form of parallel strands (8).

4. The shielded pipe (1) according to embodiment 3, wherein the parallel strands (8) are arranged in cross direction of the bandage (4).

5. The shielded pipe (1) according to at least one of the preceding embodiments, wherein the edges (14) of the carrier layer (6) are folded, such that they cover adjoining sections of the functional layer (7).

6. The shielded pipe (1) according to at least one of the preceding embodiments, wherein the bandage (4) comprises at least one sealing strand (9) in longitudinal direction of the bandage (4).

7. The shielded pipe (1) according to embodiment 6, wherein the sealing strand (9) consists of polymer foam.

8. The shielded pipe (1) according to at least one of the preceding embodiments, wherein the collar (3) has a width of 125 mm to 400 mm.

9. The shielded pipe (1) according to at least one of the preceding embodiments, wherein the functional layer is an intumescent layer.

10. The shielded pipe (1) according to at least one of the preceding embodiments, wherein functional layer is a compressed and elastic foam strip in order to provide for a structure born noise decoupling or an intumescent, compressed and elastic foam strip in order to provide for fire-resistance.

11. A wall duct (10) comprising a wall (11) having an opening (12), wherein the shielded pipe (1) of at least one of the preceding embodiments transits the opening (12), wherein a sealing (13) separates the collar (3) from the opening (12) and seals the wall duct (10).

12. A bandage (4) for shielding a chlorinated polyvinyl chloride (cPVC) pipe (2), the bandage (4) comprising a carrier layer (6) and a functional layer (7).

13. Method of using a bandage (4) of embodiment 12 for shielding a chlorinated polyvinyl chloride (cPVC) pipe (2).

### DETAILED DESCRIPTION OF THE INVENTION

A pipe is a pipeline or tube for conducting liquids. The cPVC pipe is shielded by a bandage, which is wrapped around it at least once, thereby forming the collar. The collar shields the cPVC pipe enclosed therein from the environment, especially from chemicals and fire. Preferably, the collar covers only a partial region of the cPVC pipe in longitudinal direction, which requires specific shielding, because it is in direct contact or close to potentially harmful adjoining parts or materials.

Preferably, the bandage is wrapped around the pipe more than once, for example 2 to 15 times. If the bandage is wrapped around the pipe more than once, the formation of obtuse edges or angles is avoided, through which chemicals, such as softeners, could creep to the pipe due to capillary forces.

The bandage protects the enclosed cPVC pipe against fire or smoke, or prevents fire or smoke from passing through the wall which is traversed by the shielded pipe. Additionally, the bandage provides for an acoustic sealing, In a preferred embodiment, the bandage does not comprise additional layers (besides the carrier layer and functional layer). Alternatively, it may comprise at least one other layer.

The functional layer is preferably an intumescent layer. In a preferred embodiment, the functional layer is a compressed and elastic foam strip in order to provide for a structure born noise decoupling or an intumescent, compressed and elastic foam strip in order to provide for fire-resistance.

An intumescent is a substance that swells as a result of heat exposure, thus leading to an increase in volume and decrease in density. Intumescents are typically used in passive fire protection and require listing, approval, and compliance in their installed configurations in order to comply with the national building codes and laws, such as European Union: EN 13381-8.

The carrier layer is preferably a metal layer, i.e. a layer which comprises at least one metal. In a preferred embodiment, the carrier layer is a foil. A foil is advantageous because it can be conveniently wrapped, folded and/or coated with an intumescent coating. Preferably, the carrier is a metal foil. The metal is preferably aluminum or another metal, which can be provided in the form of a foil. In another embodiment, the carrier layer is a polymer layer comprising a metallic coating, such as a plastic foil with an aluminum deposit. The bandage may comprise a reinforcement, such as a glass fiber layer, for example a glass fiber woven or non-woven.

The intumescent layer could be either a coating on the carrier layer, or it could be provided separately and laminated with the carrier layer. In a preferred embodiment, the intumescent layer has the form of parallel strands arranged in cross direction of the bandage. The strands can be polymer strands, for example from acrylate dispersion, polyvinyl acetate, polyurethane or EPDM. This has the advantage that the parallel strands can block movement of chemicals, such as softeners, from the environment into the collar and through the collar in longitudinal direction of the bandage.

In a preferred embodiment, the edges of the carrier layer are folded, such that they cover adjoining sections of the intumescent layer. This has the advantage that movement of chemicals, such as softeners, towards and into the intumescent layer, and especially into voids between parallel strands thereof can be prevented. Preferably, all four edges of the carrier layer are folded, such that chemicals cannot enter the collar from any side. In this regard, a folded edge at the terminal outer end of the collar is of special importance, because it can prevent chemicals from entering the collar.

In a preferred embodiment, the bandage comprises at least one sealing strand which is arranged in longitudinal direction of the bandage. Preferably, the sealing strand consists of polymer foam. This has the advantage that movement of chemicals, but also air, smoke or other gases, or sounds, within the collar, and thus within a wall hole through which the pipe leads, can be reduced or prevented.

In a preferred embodiment, the collar has a width of 125 mm to 400 mm, preferably from 200 mm to 300 mm. When the width is adjusted accordingly, the shielded part of the pipe fits into a conventional wall opening, whereas smaller sections of the shielded region can protrude outside the opening on both sides. This is advantageous, because the collar can fully protect the pipe from a sealing or other adjacent parts in the wall opening. The outer sections can provide further protection from environmental influences in the region which is close to the sealing and opening.

Subject of the invention is also a wall duct, comprising a wall with an opening, wherein the shielded pipe of the invention transits the opening, wherein a sealing separates the collar from the opening and seals the wall duct. Typically, the major part of the collar surface is adjacent to the sealing. Typically, the shielded pipe enters and passes the wall in certain direction. The intermediate sealing is needed to dose the gap after installing the pipe and the shield, and prevents additionally direct contact of the wall with the collar, whereas the collar prevents direct contact of the sealing with the cPVC pipe. Overall, the wall duct is sealed, such that liquids or gases cannot traverse the wall. However, the shielded pipe may also be used as a floor or ceiling penetration or the like.

Subject of the invention is also a bandage for shielding a cPVC pipe, the bandage comprising a carrier layer and a functional layer. Typically, the bandage is wrapped around a central core. The bandage can be unwrapped and stripes of desired length can be cut off and used for wrapping the cPVC pipe. The bandage is for producing a shielded pipe of the invention. Subject of the invention is also the use of a bandage of the invention for shielding a chlorinated polyvinyl chloride (cPVC) pipe. Specifically, the use is for preventing the cPVC pipe from chemicals, fire, heat and/or smoke, in particular preventing a burn-through of the bushing at this point. The specific embodiments of the bandage are preferably as outlined above in relation to the shielded pipe.

The shielded pipe solves the problem underlying the invention. The shielding protects the wrapped cPVC pipe against chemicals, fire, heat, smoke and the like. The shielded pipe can close and seal a wall opening in a wall duct, thereby preventing smoke, fire, gases or moisture, but also chemicals from passing through the wall. The shielded pipe can be used in direct contact with materials which may have an undesirable effect on cPVC, such as sealants or oils. Burdensome advance testing of the pipe for compatibility with materials in its environment is not required. Thus, only a single admission process is required for the manufacturer, which greatly facilitates handling, improves the efficiency and reduces manufacturing costs.

### BRIEF DESCRIPTION OF THE DRAWINGS

The above embodiments and aspects of the invention are outlined further in the following examples and figures. The figures are schematic and the dimensions could be, but are not necessarily, drawn to scale. The figures show:

FIG. 1 a schematic view of a wall duct which is traversed by the shielded pipe of the invention

FIG. 2 a schematic view of a bandage of the invention

FIG. 3 an enlarged schematic view of the wall duct of FIG. 1

FIG. 4 a schematic view of an embodiment of the bandage with parallel strands of functional layer

FIG. 5 an enlarged view of an embodiment of the bandage with parallel strands of functional layer and folded edges

FIG. 6 a schematic view of an embodiment of the bandage with parallel strands of functional layer and sealing strands.

### DETAILED DESCRIPTION OF EMBODIMENTS

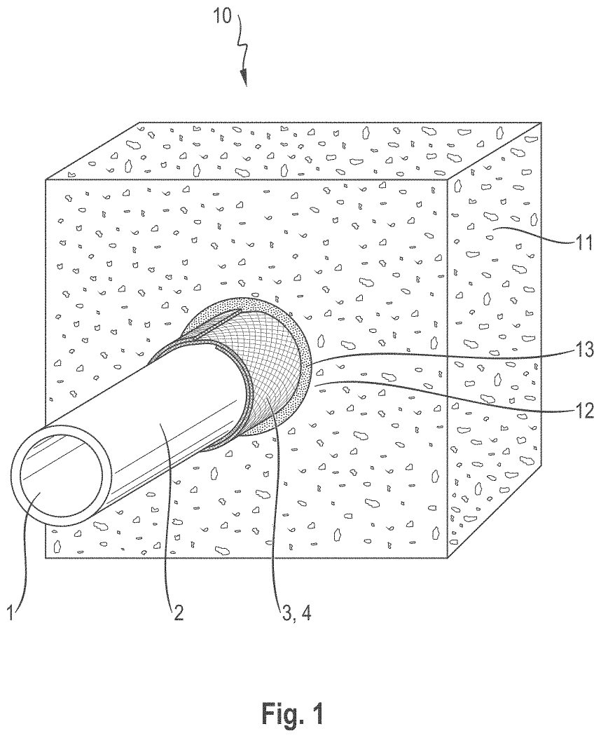

FIG. 1 shows an embodiment of a wall duct 10. The shielded pipe 1, consisting of a cPVC pipe 2 with collar 3 from bandage 4, traverses an opening 12 of wall 11. A sealing 13 is located between opening 12 and collar 3, which seals opening 12 and can also fixate the shielded pipe 1 in the opening 12. In the embodiment shown, bandage 4 is wrapped twice around cPVC pipe 2. The intumescent layer of bandage 4 can prevent fire from passing the wall 11, whereas the carrier layer can provide an efficient barrier against chemicals, such as softeners. The shielded pipe 1 can advantageously be used in such a system without the need for prior testing the compatibility with the sealing 13 or other components.

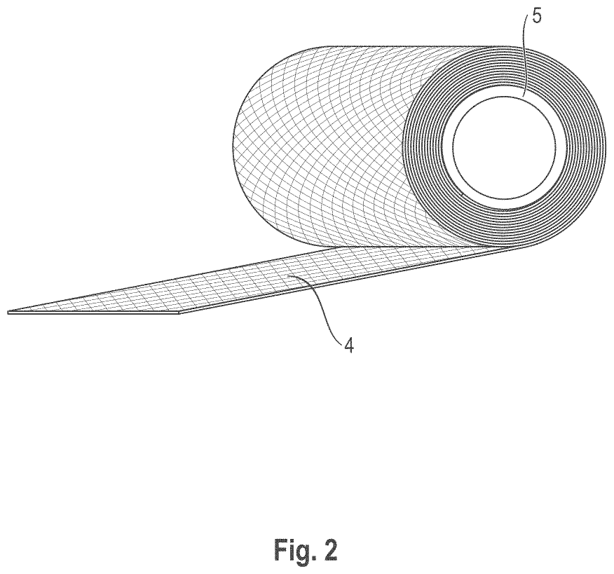

FIG. 2 shows a schematic view of bandage 4 for shielding a cPVC pipe. Bandage 4 is wrapped up repeatedly around core 5. Typically, the width of bandage 4 depends from the thickness of a wall, into which the shielded pipe shall be inserted, with overhangs on each side.

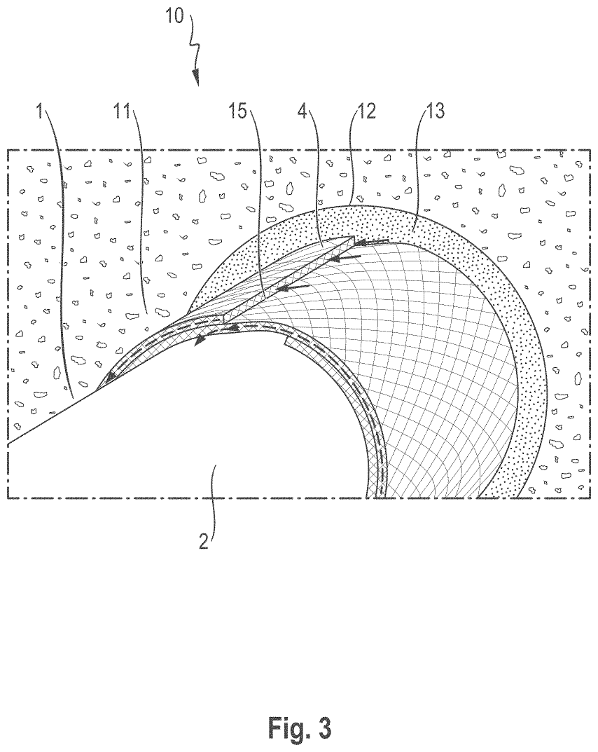

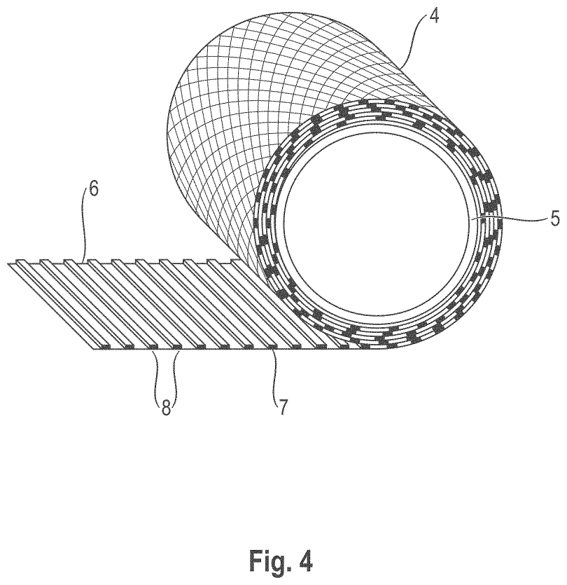

FIG. 3 shows a schematic and view of an embodiment of a wall duct 10, which is enlarged at the position at which shielded pipe 1 enters a wall 11. As also shown in FIG. 1, the bandage 4 is wrapped around cPVC pipe 2 to form a collar, which contacts the circular sealing 13 in wall opening 12. In principle, when entering the cutting edge 15 in direction of the arrows, chemicals such as softeners could diffuse out of sealing 13 into voids of the collar, creep along voids between layers of bandage 4, and may finally even contact cPVC pipe 2. However, such undesirable creeping of chemicals into the collar can be prevented according to the invention by providing the functional layer in the form of parallel stripes, as shown in FIG. 4.

In FIG. 4, an embodiment of bandage 4 is shown in schematic view comprising carrier layer 6 and on its surface functional layer 7 in the form of parallel strands 8. When such a bandage 4 is wrapped around a cPVC pipe, internal parallel voids are present between strands 8. Thereby, the parallel strands favor movement of chemicals in a direction parallel to the strands 8, which neither results in undesirable contact with the cPVC pipe, nor undesirable passage through the wall opening. Thus, the parallel strands 8 inhibit movement of chemicals into the collar in direction towards the cPVC pipe. Contact of chemicals with the cPVC pipe can be prevented further by wrapping the bandage around the cPVC pipe multiple times, for example at least two or three times.

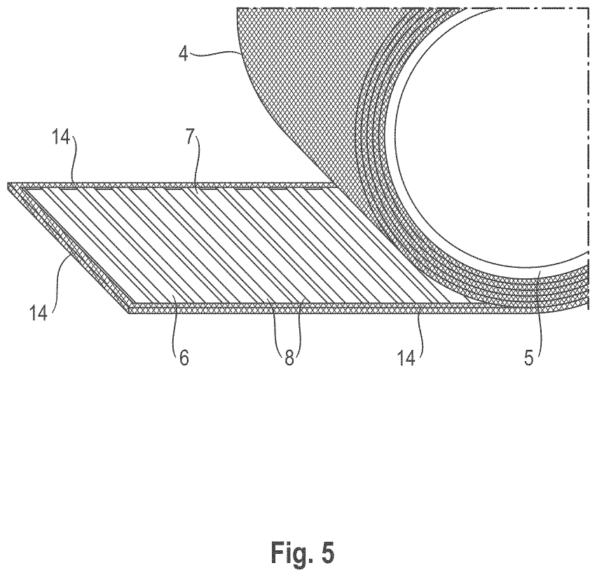

FIG. 5 shows a schematic and enlarged view of an embodiment of bandage 4 with carrier layer 6 and functional layer 7 as parallel strands 8, in which the edges 14 of carrier layer 6 are folded, such that they cover adjoining sections of the functional layer 7. Thereby, intrusion of chemicals, but also gas, smoke or moisture, into the collar can be prevented. The arrows indicate the folding direction of the edges 14. When the bandage 4 is provided in roll form, as shown in FIG. 2, 4, 5 or 6, the shielded pipe 1 is prepared by unwinding bandage 4 and cutting a section having a desired length. Preferably, the terminal sections of carrier layer 6 are folded into edges 14, which cover adjoining regions of the functional layer 7. It is advantageous that the carrier layer 6 is a metal foil, especially aluminum foil, because it can be folded easily and maintains its shape after folding. By folding all four edges, all sides of the collar can be protected against the environment, thereby providing an overall tightly packed and closed collar for the cPVC pipe.

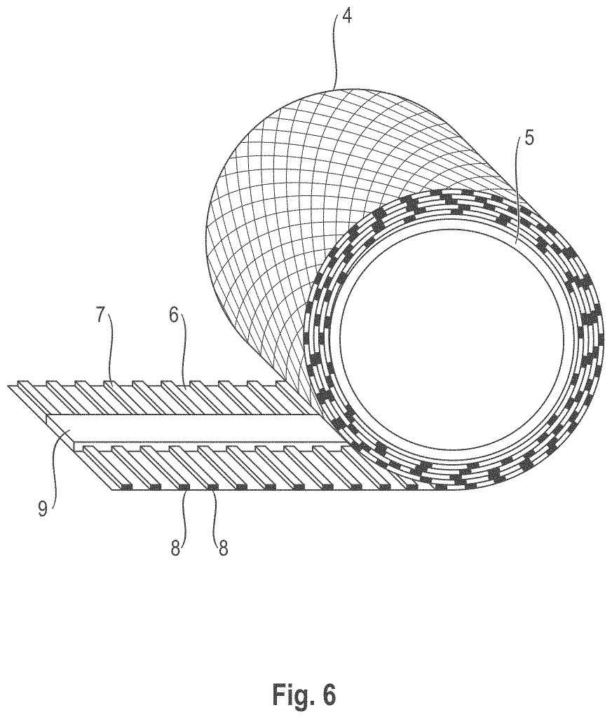

FIG. 6 shows a schematic view of an embodiment of a bandage 4, as described above, which further comprises sealing strands 9 arranged in longitudinal direction of the bandage 4. The sealing strands 9 provide an internal barrier against undesirable movement of chemicals, smoke, moisture, sound, smells or the like in cross direction of bandage 4. Preferably, sealing strand 9 is in central position. Preferably, it is elastic and can be compressed, such that efficient internal sealing of the cPVC pipe is achieved. It is preferred that sealing strand 9 is slightly higher than the parallel stands 8 of functional layer, because this can improve overall tightness of the collar. Preferably, sealing strand 9 consists of plastic foam, which may consist of EPDM, PE or polyurethane, and which preferably does not comprise softeners. Preferably, in the shielded pipe the terminal outer end of sealing strand 9 is not in direct contact with sealing 13 in wall opening 12. Preferably, the bandage 4 comprises an outer folded edge 14, which also covers the terminal outer end of the sealing strand 9, thereby preventing contact with the sealing 13. The terminal edge of sealing strand 9 may also be covered with adhesive tape, such as aluminum tape.

When the shielded pipe 1 traverses a wall 11 in a wall duct 10, as shown in FIG. 1 or FIG. 3, the width of collar 3 is typically the same as the width of bandage 4, and preferably about 250 to 300 mm. In this regard, it is preferred that the width of the collar 3 and/or bandage 4 is the sum of the thickness of the wall and additional sections of at least 50 mm on each side of the wall opening. For example, for a wall having a thickness of 150 mm, the collar should have a length of at least 250 mm, such that it can protrude at least 50 mm out of the wall on each side. This is advantageous, because the protection by the collar against chemicals or fire is extended to sections outside the wall opening, which may for example contact chemicals from the wall under strain or stress.

### LIST OF REFERENCE SIGNS

1 shielded pipe

2 cPVC pipe

3 collar

4 bandage

5 core

6 carrier layer

7 functional layer

8 parallel strands

9 sealing strand

10 wall duct

11 wall

12 opening

13 sealing

14 edge

15 cutting edge

1. A shielded pipe, comprising:
a pipe from chlorinated polyvinyl chloride (cPVC), and
a collar which shields the cPVC pipe from the environment,
wherein the collar comprises a bandage which is wrapped around the cPVC pipe, and wherein the bandage comprises a carrier layer and a functional layer.

2. The shielded pipe according to claim 1, wherein the carrier layer is a metal foil.

3. The shielded pipe according to claim 1, wherein the functional layer has a form of parallel strands.

4. The shielded pipe according to claim 3, wherein the parallel strands are arranged in cross direction of the bandage.

5. The shielded pipe according to claim 1, wherein edges of the carrier layer are folded to cover adjoining sections of the functional layer.

6. The shielded pipe according to claim 1, wherein the bandage comprises at least one sealing strand in a longitudinal direction of the bandage.

7. The shielded pipe according to claim 6, wherein the sealing strand consists of polymer foam.

8. The shielded pipe according to claim 1, wherein the collar has a width of 125 mm to 400 mm.

9. The shielded pipe according to claim 1, wherein he functional layer is an intumescent layer.

10. The shielded pipe according to claim 1, wherein the functional layer is a compressed and elastic foam strip configured to provide a structure born noise decoupling, or wherein the functional layer is an intumescent, compressed and elastic foam strip configured to provide fire-resistance.

11. A wall duct, comprising:
a wall having an opening,
wherein the shielded pipe of claim 1 transits the opening, and wherein a sealing separates the collar from the opening and seals the wall duct.

12. A bandage for shielding a chlorinated polyvinyl chloride (cPVC) pipe, the bandage comprising:
a carrier layer, and
a functional layer.

13. A method of shielding a pipe, comprising:
wrapping the bandage of claim 12 around a chlorinated polyvinyl chloride (cPVC) pipe.
